(19) United States
(12) Patent Application Publication
(10) Pub. No.: US 2010/0170094 A1
(43) Pub. Date: Jul. 8, 2010

(54) SAFETY RAZOR

(76) Inventor: Takashi HAYASHI, Fujisawa-shi (JP)

Correspondence Address: JORDAN AND HAMBURG LLP, 122 EAST 42ND STREET, SUITE 4000, NEW YORK, NY, 10168, US

(21) Appl. No.: 12/565,042

(22) Filed: Sep. 23, 2009

(30) Foreign Application Priority Data
Jan. 6, 2009 (JP) 000527/2009

(51) Int. Cl. B26B 21/40

(52) U.S. Cl. 30/50; 30/526

(57) ABSTRACT

A safety razor includes a plurality of razor blades, a frame fixedly holding each razor blade to cause its cutting edge to be outwardly exposed, and a holder for reversibly holding the frame. Each razor blade is formed to provide two edges. In other words, each razor blade is provided to cause its upper and lower cutting edges to be outwardly exposed, sloping away from the frame. The frame is formed in a frame shape to hold each razor blade between the right and left sections thereof and fixedly houses each razor blade within the inner space causing each razor blade to slope away at regular intervals and in parallel. In this manner, each razor blade can be used twice with its two edges.

### BACKGROUND OF THE INVENTION

1. Field of the Invention

The present invention relates to a safety razor, and more particularly to a safety razor which is a means for use in shaving.

2. Description of the Prior Art

A safety razor composed of razor blades, a frame or a plate platform and a holder is known.

In other words, a safety razor consisting of razor blades, a frame for fixedly holding each razor blade (or a plate platform for attaching each razor blade therebetween) to cause its cutting edge to be outwardly exposed, and a holder for holding a head composed of the razor blade and the frame (or plate platform) are known.

In a conventional safety razor of this kind, the razor blade has been provided with a single edge. The single edge of each razor blade was exposed out of the frame (or plate platform) holding the razor blade when used in shaving. In other words, the cutting edge was formed only on one long side of the rectangular razor blade during shaving.

3. Problems to be Solved by the Invention

In the conventional safety razor of this kind, the following problems have been pointed out. The conventional safety razor is the so-called replacement blade type and once the razor has lost its edge, the head itself is replaced with a new one.

In other words, in such a safety razor, when a razor blade with a single edge has lost its edge, a head consisting of the razor blade and a frame (or plate platform) for holding the razor blade is removed from a holder for disposal. Instead, a new head, that is, a frame (or plate platform) with a new razor blade was attached to the holder as a replacement.

Further, in the conventional safety razor of this kind, a problem of increased expenses has been pointed out. In other words, the head, that is, the frame (or plate platform) with razor blades must be newly purchased periodically for replacement and as a result, the burden of expense increases.

### SUMMARY OF THE INVENTION

### 1 Present Invention

In view of such actual conditions of the conventional technology of this kind, a safety razor of the present invention has been developed to solve the problems stated above.

It is therefore an object of the present invention to provide an improved safety razor in which, first, the burden of expense can be reduced, second, the cost reduction can be realized without difficulty, and, third, bending and twisting of each razor blade can also be controlled.

### 2 Means for Solving the Problems

Each aspect for solving the problems is described below.

### Aspect 1

A safety razor according to aspect 1 comprises a plurality of razor blades, a frame for fixedly holding each razor blade to cause its cutting edge to be outwardly exposed, and a holder for reversibly holding the frame, wherein each razor blade is formed to provide two edges.

### Aspect 2

The safety razor according to aspect 1 is provided, in which the razor blade is formed in a rectangular shape and its upper and lower cutting edges are outwardly exposed, sloping away from the frame.

### Aspect 3

The safety razor according to aspect 2 is provided, in which the frame is formed in a frame shape to hold each razor blade between the right and left sections and houses each razor blade within the inner space causing the razor blades to slope at regular intervals and in parallel.

### Aspect 4

The safety razor according to aspect 3 is provided, in which the holder is provided with a proximal end and distal ends, the proximal end can be gripped as a handle, while, at the distal ends, a head comprising each razor blade and the frame can be reversed 180 degrees, can be positioned to be held by stopping rotation, and can be removed to be replaced, wherein each razor blade can be used twice thanks to its two edges.

### Aspect 5

The safety razor according to aspect 3 is provided, in which supporting members are set between the front and rear sections of the frame and the razor blades facing each other and spacer members are set between the razor blades facing each other, wherein the supporting members and the spacer members serve to control bending and twisting of the razor blades to maintain the parallel relationship of the razor blades at regular intervals.

### Aspect 6

The safety razor according to aspect 5 is provided, in which the supporting members and the spacer members are respectively formed in a substantially pimple (small projection) shape and are disposed at regular intervals in a lateral direction.

### Aspect 7

The safety razor according to aspect 6 is provided, in which the supporting members and the spacer members are installed in a row in a linear positional relationship in the front and rear direction.

### 3 Effects of the Invention

(First Effect)

First, the burden of expense can be reduced. In other words, in a safety razor according to the present invention, each razor blade with two edges is employed for the first time.

A cutting edge of each razor blade on one side is first positioned on the surface side for use. Once sharpness of each cutting edge on one side deteriorates after use, the cutting edge of each razor blade on the other side which is positioned on the reverse side is used instead.

In other words, a head held at the distal end of a holder, that is, a frame with a plurality of razor blades is reversed 180 degrees relative to the distal end of the holder to be positioned for holding. With this, each cutting edge of the razor blade on the other side situated on the reverse side is now situated on the surface side for use, wherein each cutting edge on one side situated on the surface side recedes on the reverse side.

In this manner, as each razor blade of the safety razor according to the present invention is provided with two edges, it can be used twice. In other words, in the safety razor of the present invention, each razor blade can be used twice, once on each side.

In the case of a conventional safety razor of this kind as described above, when the sharpness of the cutting edge of a razor blade with a single edge deteriorates, it is necessary to replace the head itself for disposal. As compared to this, the safety razor according to the present invention has an effect by which the burden of expense can be reduced by half.

(Second Effect)

Second, the first effect can be readily realized. In other words, the safety razor of the present invention is provided with a razor blade with two edges, wherein a head consisting of such a blade and a frame is maintained to be reversible relative to a holder.

In this manner, the safety razor of the present invention has an effect by which the first effect of cost reduction as described can be readily realized with a simple structure.

(Third Effect)

Third, bending and twisting of each razor blade can also be controlled. In other words, in the safety razor of the present invention, supporting members are set between the frame and the mutually facing razor blades and further, spacer members are set between the razor blades which are facing each other. The supporting members and the spacer members are linearly installed in a row in the front and rear direction.

In the safety razor of the present invention, each razor blade of which the right and left ends are simply held between the right and left sections of the frame is immovably maintained by the spacer members and supporting members. Thus, a parallel relationship of the razor blades kept at regular intervals is maintained during use and as a result, bending and twisting of each razor blade can be surely controlled.

In this manner, the safety razor of the present invention has an effect by which it can be freely used without bending and twisting.

As described in the first through third effects, the effects brought by the present invention are remarkable in that all the problems of the conventional safety razor of this kind can be solved.

### BRIEF DESCRIPTION OF THE DRAWINGS

The above and other objects, features and advantages of the present invention will become more apparent from the following description when taken in conjunction with the accompanying drawings.

FIG. 1 is an entire perspective view of a safety razor according to the present invention describing the best mode for implementing the invention;

FIG. 2 is a plan view of an essential part of the safety razor describing the best mode for implementing the present invention; and

FIG. 3 is an exploded perspective view of the essential part of the safety razor describing the best mode for implementing the present invention.

### DETAILED DESCRIPTION OF THE PREFERRED EMBODIMENTS

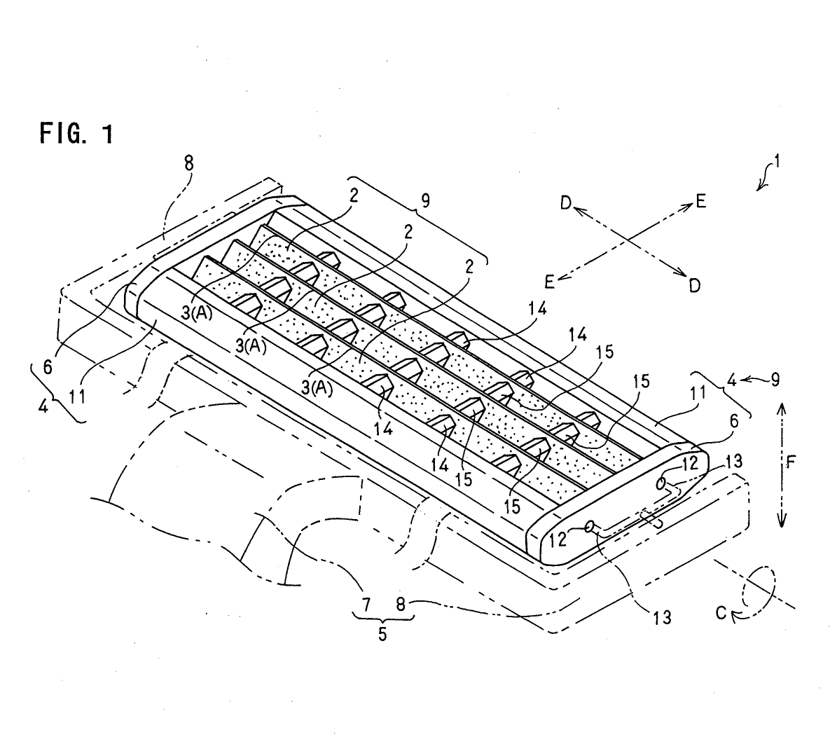

A safety razor of the present invention will now be described in detail based on the best mode for implementing the invention as shown in FIGS. 1, 2 and 3.

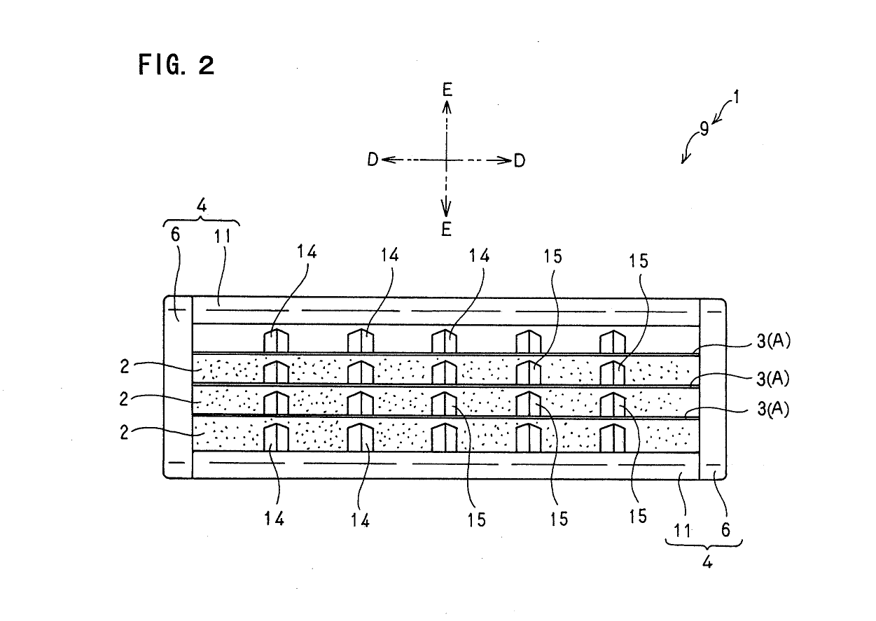

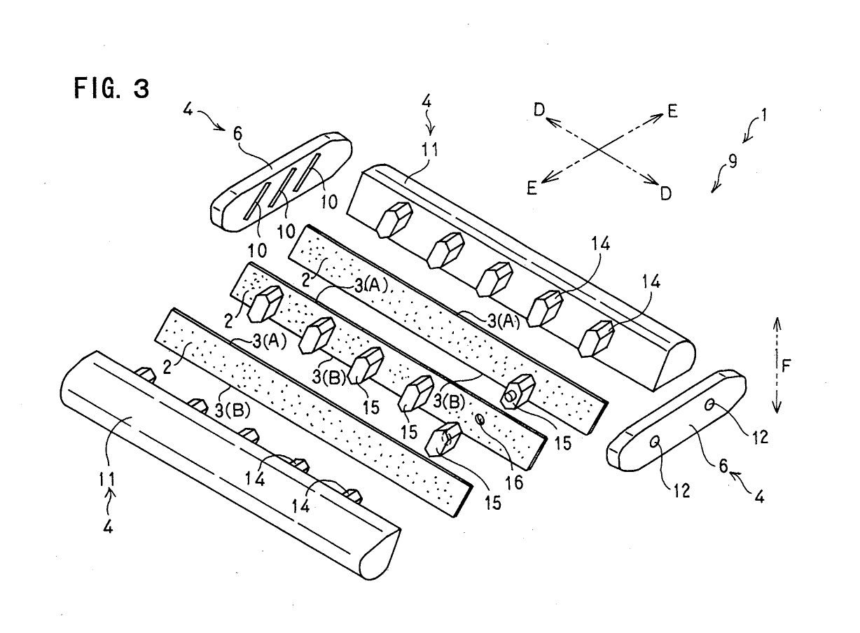

FIGS. 1, 2 and 3 are provided to describe the best mode for implementing the present invention. FIG. 1 is an entire perspective view of the safety razor, FIG. 2 is a plan view of an essential part of the safety razor, and FIG. 3 is an exploded perspective view of the essential part thereof.

(Outline of the Present Invention)

An outline of the present invention will be described with reference to the drawings.

A safety razor 1 of the present invention comprises a plurality of razor blades 2, a frame for fixedly holding each razor blade 2 to cause its cutting edge to be outwardly exposed, and a holder 5 for reversibly holding the frame 4.

Each razor blade 2 is provided with two edges 3. Namely, the razor blade 2 of a rectangular shape is provided in such a manner that the upper and lower cutting edges 3 are outwardly exposed sloping away from the frame 4. In this manner, the razor blade 2 can be used twice thanks to its two edges 3.

The frame 4 is formed in a frame shape. The frame 4 not only holds each razor blade 2 between the right and left sections 6 thereof, but also houses each razor blade 2 within the inner space leaving a space between them and causing each razor blade 2 to slope in a parallel condition.

The holder 5 has a proximal end 7 which can be used as a handle. The holder 5 also has distal ends 8 at which a head 9 consisting of each razor blade 2 and the frame 4 can be reversed 180 degrees, can be positioned to be held by stopping rotation, and can be replaced.

### DETAILED DESCRIPTION OF THE PRESENT INVENTION

A safety razor of the present invention will now be described in detail.

First, a razor blade 2 is formed in a rectangular shape and both the upper and lower long sides form the cutting edge 3. Both the right and left short sides are fixedly retained by the frame 4.

Two to five razor blades are used. FIGS. 1 through 3 show a typical example in which three blades are used. The razor blades 2 are maintained in parallel at regular intervals in the front and rear direction in a condition in which the razor blade 2 is fixedly held within the inner space of the frame 4. For example, each razor blade 2 is caused to slope at an angle of about 45 degrees relative to the upper and lower virtual horizontal surface.

Each of the upper and lower cutting edges 3 exposed from the frame 4 which houses each razor blade 2 is situated facing the virtual same surface together with the cutting edges 3 on one side A and on the other side B. The upper and lower virtual surfaces are mutually kept in a parallel relationship.

The (upper and lower) cutting edges 3 of the razor blade 2 on one side A and on the other side B are provided to slope, for example, at an angle of about 45 degrees, relative to the virtual surface.

The frame 4 is made of synthetic resins and is formed in a rectangular frame shape. The frame 4 is provided with an inner space in which a plurality of razor blades 2 can be slantingly housed.

The frame 4 is slantingly provided with a plurality of retaining grooves 10 on an inner surface of the right and left sections 6 on the short side thereof to face each other (refer to FIG. 3). Fitted into these retaining grooves 10 are end sections of the razor blade 2 on the lateral side. Thus, each razor blade 2 is fixedly held between the right and left sections 6 of the frame 4.

The inner surface of both the front and rear sections 11 of the frame 4 on the long side in the front and rear direction is set in a parallel relationship with each razor blade 2. Also, the upper and lower surface of the right and left sections 6 and the front and rear sections 11 of the frame 4, that is, the surface and the back, form a substantially common surface with the surface which the cutting edges are facing.

The outer surface of the right and left sections 6 of the frame 4 on the short side is provided with two retaining openings 12 into which two retaining members 13 of the distal ends 8 of the holder 5 on the right and left side are fitted. In this manner, the frame 4 is reversibly attached to the holder 5.

A head 9 of the safety razor 1 is composed of each razor blade 2 and the frame 4. An assembly of each razor blade 2 and the frame 4 is referred to as an assembly head 9.

The head 9 becomes in rotational symmetry by making an imaginary center line between the right and left sections 6 of the frame 4, that is, the right and left axis connecting the vertical center to the front and rear center an axis of rotation. As shown in FIG. 1, when rotated in the rotational direction C of a clockwise or counterclockwise direction, each razor blade 2 and the frame 4 of the head 9 become in rotational symmetry in the vertical direction and the like.

Accordingly, by reversing the head 9 180 degrees relative to the holder 5 to be retained, both the upper and lower surfaces thereof can be used in the same condition. In this manner, each razor blade 2 and the frame 4 of the head 9 are provided in such a manner that the front and the back can be used in the same condition due to reversal.

As shown in FIG. 1, the holder 5 holds the head 9 composed of the frame 4 and each razor blade 2 by fitting two retaining members 13 of the distal ends 8 on the right and left side into two retaining openings 12 of the right and left sections 6 of the frame 4, respectively.

The head 9 is made detachable by removing the two retaining members 13. Referring to FIG. 1, the head 9 can be reversed 180 degrees relative to the holder 5 for positioning by the operation to remove the head 9, repositioning and reinserting the retaining members 13. Further, when using a so-called replacement blade, a new head 9 can be inserted into the holder 5 according to the procedure described above.

Referring to FIG. 1, the head 9 is attached to the distal ends 8 of the holder 5 by the engagement of the retaining openings 12 and the retaining members 13, but other head attachment methods can also be employed. For example, an attachment method whereby the head 9 can be reversed 180 degrees for positioning by adoption of a rotational axis, an attachment section, a stopper and the like is also available without removing the head 9 from the holder 5 as shown in FIG. 1.

As described above, the safety razor 1 according to the present invention is provided with the razor blade 2 having two edges 3, wherein once the cutting edge 3 of the razor blade 2 on one side A lost its edge, the frame 4 and the head 9 can be reversed together relative to the holder 5 so that the cutting edge 3 on the other side B can be used.

In other words, the cutting edge 3 on one side A which was used on the front surface side becomes the back side, while the cutting edge 3 on the other side B which was the back side can be used as the front surface side.

In FIGS. 1 through 3, reference alphabet D shows the lateral direction, E shows the front and rear direction and F shows the vertical direction, respectively.

(Outline of Supporting Members 14 and Spacer Members 15)

An outline of supporting members 14 and spacer member 15 will now be described hereunder.

In the safety razor 1 of the present invention, supporting members 14 are set between the front and rear sections 11 of the frame 4 and the razor blades 2 which are facing each other, while spacer members 15 are set between the razor blades 2 which are facing each other. The supporting members 14 and the spacer members 15 serve to control bending and twisting of each razor blade 2 to maintain the parallel relationship of the razor blades 2 at regular intervals.

Both the supporting members 14 and the spacer members 15 are respectively formed in a substantially pimple (small projection) shape. They are installed at regular intervals in the lateral direction D and installed in a row in the linear positional relationship in the front and rear direction E.

(Detailed Description of Supporting Members 14 and Spacer Members 15)

The supporting members 14 and the spacer members 15 will now be described in detail.

Both ends of each razor blade 2 used in the present invention are held between the right and left section 6 of the frame 4 to be reversible as described above. In this safety razor 1, it is to be noted that the vertical ends or the front and rear ends of each razor blade 2 are not held, but the right and left ends of the razor blade 2 are held.

However, there is a worry that, when pressing force from a beard or skin is applied to the razor blade 2 in the front and rear direction E during shaving, the razor blade 2 is caused to bend or twist.

To eliminate such a worry, the supporting members 14 and the spacer members 15 are set along the front and rear direction E to hold each razor blade 2 in the front and rear direction E, thereby reinforcing the rigidity and strength of each razor blade 2 in the front and rear direction E.

In this manner, the razor blade 2 can be held immovably without being bent or twisted in the front and rear direction E.

Referring to FIGS. 1 through 3, five (5) supporting members 14 are fixed to the inner surface of the front and rear sections 11 of the frame 4 leaving an equal space in the lateral direction D. The supporting members 14 are typically made of synthetic resin and can be integrally formed with the front and rear section 11 of the frame 4 or its proximal end can be bonded to the front and rear sections 11 of the frame 4 by means of adhesion or the like.

The supporting members 14 are formed in a hexagonal pole shape in FIG. 3, but can be formed in a column-shape, a square pole shape or a pillaret shape. The distal ends of the supporting member 14 are provided to touch a side surface of the razor blade 2 which is facing each other.

On the other hand, five (5) spacer members 15 are fixed to the front and rear sides of one razor blade 2 situated between two razor blades 2, respectively (namely, one razor blade 2 situated between the front and rear razor blades 2 in FIGS. 1 through 3) leaving an equal space in the lateral direction D.

The spacer members 15 are typically made of synthetic resin, but can be made of metal. In the case where the space members 15 are made of metal, the space members 15 are secured to both sides of the razor blade 2 which is an object to be secured, by means of welding or the like.

In the case of the spacer members 15 being made of synthetic resin, it can be considered that each razor blade 2 which is an object to be secured is provided with an opening 16 (refer to FIG. 3) at regular intervals and both spacer members 15 are attached to the razor blade 2 through the opening 16 making use of the concavity and convexity provided on the opposite surface. With this, both the front and rear spacer members 15 can be secured to the front and rear sides of the razor blade 2 on the proximal ends.

The spacer member 15 can follow the shape of the supporting member 14 as described above, but the same shape as the supporting member 14 is adopted here.

The distal end of each spacer member 15 is provided to touch the side surface of the razor blade 2 which is facing each other.

In this manner, in the safety razor 1 shown in FIGS. 1 through 3, five spacer members 15 are respectively attached to the front and rear sides of one central razor blade 2 of three razor blades 2 in the front and rear direction E. Likewise, five supporting members 14 are attached to the inner surface of the front and rear sections 11 of the frame 4, respectively.

From the viewpoint of the positional relationship of each supporting member 14 and spacer member 15 in the front and rear direction E, these are linearly installed side by side in the front and rear direction E. Referring to FIGS. 1 through 3, 5 members each of the supporting members 14 and spacer members 15 are linearly installed side by side in the lateral direction D, while from the viewpoint of the front and rear direction E, 4 members consisting of 2 supporting members 14 and 2 spacer members 15 are linearly installed side by side.

In the safety razor 1 according to the present invention, since the supporting members 14 and the spacer members 15 are set between the frame 4 and the razor blades 2 and between the razor blades 2, it is possible to prevent bending and twisting of the razor blades during use.

1. A safety razor comprising a head and a holder for reversibly holding the head, the head comprising a plurality of razor blades each having two cutting edges and a frame for fixedly holding each razor blade with the cutting edges thereof outwardly exposed.

2. The safety razor according to claim 1, wherein each of the razor blades is of a rectangular shape, the cutting edges being situated at longer sides of the rectangles and the razor blades being oriented obliquely relative to the frame.

3. The safety razor according to claim 2, wherein the frame defines a space in which the razor blades are held between lateral sides of the frame at regular intervals and in parallel to each other and to longitudinal sides of the frame.

4. The safety razor according to claim 3, wherein the holder is provided with a proximal end and distal ends, the proximal end being grippable as a handle, and, at the distal ends, the head being removably mounted in the frame and being supported in the frame for rotation of the head in the frame to alternate fixed positions 180 degrees apart so that one or the other of the two cutting eges of each of the razor blades faces a surface to be shaved, thereby doubling useful life of the razor blades, and the head, after removal thereof from the frame, being replaceable with a like head.

5. The safety razor according to claim 3, wherein the head further comprises supporting members situated between the longitudinal sides of the frame and the razor blades, and spacer members situated between the razor blades, the supporting members and the spacer members being provided at regular intervals to minimize bending and twisting of the razor blades and to maintain the parallel relationship of the razor blades.

6. The safety razor according to claim 5, wherein the supporting members and the spacer members are of substantially smaller lateral cross-section than the razor blades so as not to obstruct the cutting edges.

7. The safety razor according to claim 6, wherein the supporting members and the spacer members are aligned in rows extending between the longitudinal sides of the frame.
